(19) United States
(12) Patent Application Publication
(10) Pub. No.: US 2013/0185119 A1
(43) Pub. Date: Jul. 18, 2013

(54) DYNAMIC GOAL-ORIENTED PLANNING

(71) Applicants: Francisco Palao, Armilla (Granada) (ES); Tomás Garzón, Churriana de la Vega (Granada) (ES); Juan Fernández, Granada (ES); Luis Castillo, Cajar (Granada) (ES); Óscar Garcia, Armilla (Granada) (ES)

(72) Inventors: Francisco Palao, Armilla (Granada) (ES); Tomás Garzón, Churriana de la Vega (Granada) (ES); Juan Fernández, Granada (ES); Luis Castillo, Cajar (Granada) (ES); Óscar Garcia, Armilla (Granada) (ES)

(73) Assignee: IActive Intelligent Solutions S.L., Granada (ES)

(21) Appl. No.: 13/720,996

(22) Filed: Dec. 19, 2012

Related U.S. Application Data
(60) Provisional application No. 61/577,103, filed on Dec. 19, 2011.

(51) Int. Cl. G06Q 10/06

(52) U.S. Cl. CPC G06Q 10/0637
USPC 705/7.36

(57) ABSTRACT

In general, one aspect of the subject matter described herein can be embodied in methods that include the actions of: receiving a goal-identifier corresponding to an achievement of one or more objectives and including actor parameters, resource parameters, and/or constraints, processing the goal-identifier against templates, each of which include methods that include actor parameters, resource parameters, constraints, and/or tasks, the tasks including actor parameters, resource parameters, and/or constraints, in order to identify templates and/or tasks having comparable respective actor parameters, resource parameters, and/or constraints, monitoring for changes with respect to the actor parameters, resource parameters, and/or constraints of the goal-identifier, based on a determination of the one or more changes, further processing the goal-identifier against the templates in order to identify, with respect to the one or more changes, templates and/or tasks having comparable actor parameters, resource parameters, and/or constraints, and implementing the templates/tasks with respect to the goal-identifier.

### CROSS-REFERENCE TO RELATED APPLICATIONS

This application claims the benefit of U.S. Patent Application Ser. No. 61/577,103, filed Dec. 19, 2011, which is hereby incorporated by reference in its entirety.

### BACKGROUND

It has been observed that planning in advance of a large or wide scale project is attendant with numerous challenges. For example, within an organization, various personnel have varying skills, abilities, and/or working capacities. Similarly, within each circumstance, certain resources may be required and/or available for use. Moreover, over the course of execution of a plan, various changes may occur. It is with respect to these and other considerations that the disclosure made herein is presented.

### SUMMARY

This specification describes technologies relating to dynamic planning.

In general, one aspect of the subject matter described in this specification can be embodied in methods for dynamic planning. The method includes the actions of: receiving a goal-identifier, the goal-identifier corresponding to an achievement of one or more objectives and including one or more actor parameters, one or more resource parameters, and/or one or more constraints, processing, with one or more processors, the goal-identifier against a plurality of templates, each of the templates including one or more methods, each of the one or more methods including one or more actor parameters, one or more resource parameters, one or more constraints, and/or one or more tasks, and each of the one or more tasks including one or more actor parameters, one or more resource parameters, and/or one or more constraints, in order to identify at least one of one or more of the plurality of templates and one or more of the one or more tasks having comparable respective actor parameters, resource parameters, and/or constraints, monitoring for one or more changes with respect to at least one of the one or more actor parameters, the one or more resource parameters, and/or the one or more constraints of the goal-identifier, based on a determination of the one or more changes, further processing the goal-identifier against the plurality of templates in order to identify, with respect to the one or more changes, at least one of one or more of the plurality of templates and one or more of the one or more tasks having comparable respective actor parameters, resource parameters, and/or constraints, and implementing the at least one of one or more of the plurality of templates and/or one or more of the one or more tasks with respect to the goal-identifier.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is a high-level diagram illustrating an exemplary configuration of a dynamic planning system;

FIG. 2 depicts a flow diagram showing a routine that illustrates a broad aspect of a method for dynamic planning in accordance with at least one embodiment disclosed herein;

FIG. 3 depicts a flow diagram showing a routine that illustrates a broad aspect of a method for dynamic planning in accordance with at least one embodiment disclosed herein;

FIG. 4 depicts a flow diagram showing a routine that illustrates a broad aspect of a method for dynamic planning in accordance with at least one embodiment disclosed herein;

FIG. 5 depicts a flow diagram showing a routine that illustrates a broad aspect of a method for dynamic planning in accordance with at least one embodiment disclosed herein;

FIG. 6 depicts a flow diagram showing a routine that illustrates a broad aspect of a method for dynamic planning in accordance with at least one embodiment disclosed herein;

FIG. 7 is a high-level diagram illustrating a further exemplary configuration of a dynamic planning system;

FIG. 8 depicts a flow diagram showing a routine that illustrates a broad aspect of a method for dynamic planning in accordance with at least one embodiment disclosed herein; and

FIGS. 9-14 depict various aspects, features, operations, and illustrations of various systems and methods described herein.

Like reference symbols in the various drawings indicate like elements.

### DETAILED DESCRIPTION

By way of overview and introduction, the systems and methods described herein encompass, in certain implementations, the application of a continual temporal planner in support of the management of adaptive cases. In doing so, protocols, templates and/or doctrines (such as those generated based on past experiences, such as those occurring within an organization) can be graphically represented and/or given a context and/or a target goal, such as in a knowledge modeling environment. Additionally, an executable process can be identified/defined, based on factors such as knowledge worker demand. In certain implementations, such a process can be dispatched into/integrated within various infrastructures for execution. Moreover, the ongoing execution of the various processes can be continuously monitored, such as at regular intervals before the target goals have been achieved. Upon identifying various changes/deviations, further analysis of various known processes can be performed in order to identify new or additional processes that may provide better outcomes, such as in light of the changes/deviations. The performance of such processes can resume and be executed until all target goals have been achieved according to the protocols, templates and/or doctrines.

As described herein, methods and systems are configured to adapt a hierarchical task network, temporal and continuous planner (HTN planner) to enable the design and redesign of processes oriented to the achievement of a given pre-established goal. It can be advantageous to automatically generate processes in complex and dynamic environments in which such processes can become very complex, such as those in which a large number of alternatives are available/possible. Accordingly, customized processes can be dynamically defined/generated ‘on the fly’ according to the context in which these processes are needed. It is also advantageous for situations in which the execution of an initial processes might, at times, fail, for new processes to be generated in order to resume activity. Likewise, the general method and adapted HTN planner described herein can be advantageously employed in situations in which one or more goals change and/or need to be redefined, thereby enabling the tuning of the process during its execution according to specific preferences/circumstances.

As will be further appreciated, embodiments of the technologies described herein can be advantageously employed in adaptive case management (ACM) contexts in which described environments are common and in which state of the art methodologies of business process management (BPM) are not able to cope due to their static and machine oriented execution nature. In addition, the systems and methods described herein can improve decision support capabilities and performance of various knowledge workers by providing encoded, shareable and auditable data concerning past skills and expert knowledge in an actionable representation, such as in a way that an HTN planner is able to interpret that knowledge and operate in accordance with the expert himself or herself to efficiently design a robust, reliable and optimized timed process to meet a particular goal.

Accordingly, described herein are systems and methods for dynamic planning. The referenced systems and methods are now described more fully with reference to the accompanying drawings, in which one or more illustrated embodiments and/or arrangements of the systems and methods are shown. The systems and methods are not limited in any way to the illustrated embodiments and/or arrangements as the illustrated embodiments and/or arrangements described below are merely exemplary of the systems and methods, which can be embodied in various forms, as appreciated by one skilled in the art. Therefore, it is to be understood that any structural and functional details disclosed herein are not to be interpreted as limiting the systems and methods, but rather are provided as a representative embodiment and/or arrangement for teaching one skilled in the art one or more ways to implement the systems and methods. Accordingly, aspects of the present systems and methods can take the form of an entirely hardware embodiment, an entirely software embodiment (including firmware, resident software, micro-code, etc.), or an embodiment combining software and hardware. One of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer. Furthermore, the terms and phrases used herein are not intended to be limiting, but rather are to provide an understandable description of the systems and methods.

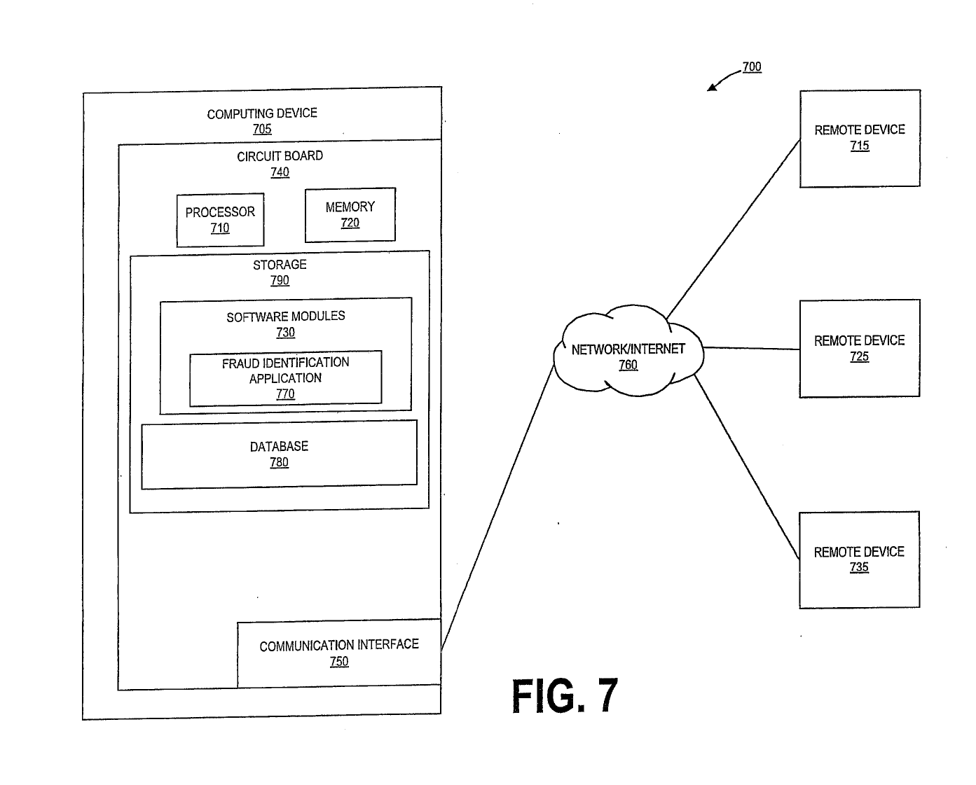

An exemplary computer system is shown as a block diagram in FIG. 7 which is a high-level diagram illustrating an exemplary configuration of a dynamic planning system 700. In one implementation, computing device 705 can be a personal computer or server. In other implementations, computing device 705 can be a tablet computer, a laptop computer, or a mobile device/smartphone, though it should be understood that computing device 705 of dynamic planning system 700 can be practically any computing device and/or data processing apparatus capable of embodying the systems and/or methods described herein.

Computing device 705 of dynamic planning system 700 includes a circuit board 740, such as a motherboard, which is operatively connected to various hardware and software components that serve to enable operation of the dynamic planning system 700. The circuit board 740 is operatively connected to a processor 710 and a memory 720. Processor 710 serves to execute instructions for software that can be loaded into memory 720. Processor 710 can be a number of processors, a multi-processor core, or some other type of processor, depending on the particular implementation. Further, processor 710 can be implemented using a number of heterogeneous processor systems in which a main processor is present with secondary processors on a single chip. As another illustrative example, processor 710 can be a symmetric multi-processor system containing multiple processors of the same type.

Preferably, memory 720 and/or storage 790 are accessible by processor 710, thereby enabling processor 710 to receive and execute instructions stored on memory 720 and/or on storage 790. Memory 720 can be, for example, a random access memory (RAM) or any other suitable volatile or non-volatile computer readable storage medium. In addition, memory 720 can be fixed or removable. Storage 790 can take various forms, depending on the particular implementation. For example, storage 790 can contain one or more components or devices such as a hard drive, a flash memory, a rewritable optical disk, a rewritable magnetic tape, or some combination of the above. Storage 790 also can be fixed or removable.

One or more software modules 730 are encoded in storage 790 and/or in memory 720. The software modules 730 can comprise one or more software programs or applications having computer program code or a set of instructions executed in processor 710. Such computer program code or instructions for carrying out operations for aspects of the systems and methods disclosed herein can be written in any combination of one or more programming languages, including an object oriented programming language such as Java, Smalltalk, C++, Python, and JavaScript or the like and conventional procedural programming languages, such as the “C” programming language or similar programming languages. The program code can execute entirely on computing device 705, partly on computing device 705, as a stand-alone software package, partly on computing device 705 and partly on a remote computer/device, or entirely on the remote computer/device or server. In the latter scenario, the remote computer can be connected to computing device 705 through any type of network, including a local area network (LAN) or a wide area network (WAN), or the connection can be made to an external computer (for example, through the Internet 760 using an Internet Service Provider).

One or more software modules 730, including program code/instructions, are located in a functional form on one or more computer readable storage devices (such as memory 720 and/or storage 790) that can be selectively removable. The software modules 730 can be loaded onto or transferred to computing device 705 for execution by processor 710. It can also be said that the program code of software modules 730 and one or more computer readable storage devices (such as memory 720 and/or storage 790) form a computer program product that can be manufactured and/or distributed in accordance with the technologies described herein, as is known to those of ordinary skill in the art.

It should be understood that in some illustrative embodiments, one or more of software modules 730 can be downloaded over a network to storage 790 from another device or system via communication interface 750 for use within dynamic planning system 700. For instance, program code stored in a computer readable storage device in a server can be downloaded over a network from the server to dynamic planning system 700.

Preferably, included among the software modules 730 is a dynamic planning application 770 that is executed by processor 710. During execution of the software modules 730, and specifically the dynamic planning application 770, the processor 710 configures the circuit board 740 to perform various operations relating to dynamic planning with computing device 705, as will be described in greater detail below. It should be understood that while software modules 730 and/or dynamic planning application 770 can be embodied in any number of computer executable formats, in certain implementations software modules 730 and/or dynamic planning application 770 comprise one or more applications that are configured to be executed at computing device 705 in conjunction with one or more applications or ‘apps’ executing at remote devices, such as computing device(s) 715, 725, and/or 735 and/or one or more viewers such as internet browsers and/or proprietary applications. Furthermore, in certain implementations, software modules 730 and/or dynamic planning application 770 can be configured to execute at the request or selection of a user of one of computing devices 715, 725, and/or 735 (or any other such user having the ability to execute a program in relation to computing device 705, such as a network administrator), while in other implementations computing device 705 can be configured to automatically execute software modules 730 and/or dynamic planning application 770, without requiring an affirmative request to execute. It should also be noted that while FIG. 7 depicts memory 720 oriented on circuit board 740, in an alternate arrangement, memory 720 can be operatively connected to the circuit board 740. In addition, it should be noted that other information and/or data relevant to the operation of the present systems and methods (such as database 780) can also be stored on storage 790, as will be discussed in greater detail below.

Also preferably stored on storage 790 is database 780. As will be described in greater detail below, database 780 contains and/or maintains various data items and elements that are utilized throughout the various operations of dynamic planning system 700, as will be described in greater detail herein. It should be noted that although database 780 is depicted as being configured locally to computing device 705, in certain implementations database 780 and/or various of the data elements stored therein can be located remotely (such as on a remote device or server—not shown) and connected to computing device 705 through network 760, in a manner known to those of ordinary skill in the art.

As referenced above, it should be noted that in certain implementations, such as the one depicted in FIG. 7, various of the computing devices 715, 725, 735 can be in periodic or ongoing communication with computing device 705 thorough a computer network such as the Internet 760. Though not shown, it should be understood that in certain other implementations, computing devices 715, 725, and/or 735 can be in periodic or ongoing direct communication with computing device 705, such as through communications interface 750, such as during an interactive multiuser session.

Communication interface 750 is also operatively connected to circuit board 740. Communication interface 750 can be any interface that enables communication between the computing device 705 and external devices, machines and/or elements. Preferably, communication interface 750 includes, but is not limited to, a modem, a Network Interface Card (NIC), an integrated network interface, a radio frequency transmitter/receiver (e.g., Bluetooth, cellular, NFC), a satellite communication transmitter/receiver, an infrared port, a USB connection, and/or any other such interfaces for connecting computing device 705 to other computing devices and/or communication networks such as private networks and the Internet. Such connections can include a wired connection or a wireless connection (e.g. using the 802.11 standard) though it should be understood that communication interface 750 can be practically any interface that enables communication to/from the circuit board 740.

As noted above, at various points during the operation of dynamic planning system 700, computing device 705 can communicate with one or more computing devices, such as those controlled and/or maintained by one or more individuals and/or entities, such as user devices 715, 725, and/or 735. Such computing devices transmit and/or receive data to/from computing device 705, thereby preferably initiating maintaining, and/or enhancing the operation of the dynamic planning system 700, as will be described in greater detail below. It should be understood that the computing devices 715-135 can be in direct communication with computing device 705, indirect communication with computing device 705, and/or can be communicatively coordinated with computing device 705, as will be described in greater detail below. While such computing devices can be practically any device capable of communication with computing device 705, in certain embodiments various of the computing devices are preferably servers, while other computing devices are preferably user devices (e.g., personal computers, handheld/portable computers, smartphones, etc.), though it should be understood that practically any computing device that is capable of transmitting and/or receiving data to/from computing device 705 can be similarly substituted.

It should be noted that while FIG. 7 depicts dynamic planning system 700 with respect to computing devices 715, 725, and 735, it should be understood that any number of computing devices can interact with the dynamic planning system 700 in the manner described herein. It should be further understood that a substantial number of the operations described herein are initiated by and/or performed in relation to such computing devices. For example, as referenced above, such computing devices can execute applications and/or viewers which request and/or receive data from computing device 705, such as in the manner described in detail herein. In the description that follows, certain embodiments and/or arrangements are described with reference to acts and symbolic representations of operations that are performed by one or more devices, such as the dynamic planning system 700 of FIG. 7. As such, it will be understood that such acts and operations, which are at times referred to as being computer-executed or computer-implemented, include the manipulation by processor 710 of electrical signals representing data in a structured form. This manipulation transforms the data and/or maintains them at locations in the memory system of the computer (such as memory 720 and/or storage 790), which reconfigures and/or otherwise alters the operation of the system in a manner understood by those skilled in the art. The data structures in which data are maintained are physical locations of the memory that have particular properties defined by the format of the data. However, while an embodiment is being described in the foregoing context, it is not meant to provide architectural limitations to the manner in which different embodiments can be implemented. The different illustrative embodiments can be implemented in a system including components in addition to or in place of those illustrated for the dynamic planning system 700. Other components shown in FIG. 7 can be varied from the illustrative examples shown. The different embodiments can be implemented using any hardware device or system capable of running program code. In another illustrative example, dynamic planning system 700 can take the form of a hardware unit that has circuits that are manufactured or configured for a particular use. This type of hardware can perform operations without needing program code to be loaded into a memory from a computer readable storage device to be configured to perform the operations.

For example, computing device 705 can take the form of a circuit system, an application specific integrated circuit (ASIC), a programmable logic device, or some other suitable type of hardware configured to perform a number of operations. With a programmable logic device, the device is configured to perform the number of operations. The device can be reconfigured at a later time or can be permanently configured to perform the number of operations. Examples of programmable logic devices include, for example, a programmable logic array, programmable array logic, a field programmable logic array, a field programmable gate array, and other suitable hardware devices. With this type of implementation, software modules 730 can be omitted because the processes for the different embodiments are implemented in a hardware unit.

In still another illustrative example, computing device 705 can be implemented using a combination of processors found in computers and hardware units. Processor 710 can have a number of hardware units and a number of processors that are configured to execute software modules 730. In this example, some of the processors can be implemented in the number of hardware units, while other processors can be implemented in the number of processors.

In another example, a bus system can be implemented and can be comprised of one or more buses, such as a system bus or an input/output bus. Of course, the bus system can be implemented using any suitable type of architecture that provides for a transfer of data between different components or devices attached to the bus system. Additionally, communications interface 750 can include one or more devices used to transmit and receive data, such as a modem or a network adapter.

Embodiments and/or arrangements can be described in a general context of computer-executable instructions, such as program modules, being executed by a computer. Generally, program modules include routines, programs, objects, components, data structures, etc., that perform particular tasks or implement particular abstract data types.

It should be further understood that while the various computing devices and machines referenced herein, including but not limited to computing device 705, computing devices 715, 725, and 735 are referred to herein as individual/single devices and/or machines, in certain implementations the referenced devices and machines, and their associated and/or accompanying operations, features, and/or functionalities can be arranged or otherwise employed across any number of devices and/or machines, such as over a network connection, as is known to those of skill in the art. It should also be noted that, although not all shown in FIG. 7, various additional components can be incorporated within and/or employed in conjunction with computing device 705.

Moreover, in certain implementations of the systems and methods described herein, any number of elements and features can be included, as will be described in detail herein. For example, in certain implementations a graphical representation of a model, such as an ACM model that includes domain concepts, and protocols or doctrine, can be employed. In such implementations, domain concepts can be modeled using a UML class diagrams. Moreover, an organization structure can be modeled using a hierarchical organization chart, as is known to those of ordinary skill in the art. Such a chart can define, for example, the members of an organization, its role, and/or the levels of security and responsibility of each of the members. In certain implementations, the referenced domain concepts and/or the organization structure can define the context model (CM). Additionally, in certain implementations, protocols and/or doctrines can be modeled using a graphical notation referred to as Expert Knowledge Modeling Notation (‘EKMN’). EKMN can be further complemented with various textual declarative languages, such as Expert Knowledge Domain Language (EKDL), which can be used to encode various aspects such as: constraints on protocols, user preferences, and/or business rules.

Additionally, a serialized XML, textual, binary or other intermediate representation of the graphical and textual elements (such as one that can be interpreted by an HTN automated temporal planner) can be employed. Such a representation can also be shared and/or modified by organization members.

An HTN automated temporal planner can be configured to generate one or more plans/processes, such as those that meet various knowledge worker needs, such as based on an intermediate model representation, a desired composition of the goals to accomplish and/or the current state of the domain concepts (environment context), such as those obtained from corporative data sources.

A serialized XML, textual, binary or other representation of the plan/process can be analyzed and/or executed in conjunction with various software tools/applications. Such a representation can also used for replanning and repairing purposes, thereby accounting for the dynamicity of various target scenarios.

A monitoring tool or application can be implemented to detect divergences from the planned process that occur during execution. The monitoring tool can trigger a repairing/replanning process using the HTN automated temporal planner.

Various machine-learning techniques and algorithms can be employed, such as in order to process previously executed processes in order to learn parameters about the effectiveness and efficiency of the process, such that such parameters can be used to detect defects in the executed process and/or to modify the model, or to further parameterize it accordingly to avoid such defects in future composition of process proposals.

It should be appreciated that any number of the referenced elements can be implemented in order to solve any number of challenges, including problems in collaboration. For example, a digitalized model of protocols can allow different knowledge workers in an organization to share its expertise, discuss it, and homogenize the way they respond in similar situations. The referenced model(s) allow for the encoding of heuristics and/or implicit rules used within the organization. Moreover, the HTN temporal planner, based on the necessary context information, can be configured to organize and/or coordinate the different actors involved in the execution of the plan, taking into account their respective capacities and restrictions in an efficient way.

Additionally, various advantages can be provided with respect to dynamicity of the environment. For example, a knowledge worker can to change the model/process at any moment to adapt a protocol to a new business scenario. Moreover, when any unexpected changes in the context, or a failure during the process execution is/are detected, the monitoring tool can invoke the HTN planner to repair the process and adapt it to the new scenario. Additionally, due to changes occurring during the process execution, new activities can be dynamically added or deleted from the process. Moreover, in certain implementations the monitor can enable the knowledge worker to manually override some constraints imposed over the process during its execution.

Moreover, in implementing the various systems and methods described herein, various decisions can be traced and policies and regulations enforced. For example, decisions can be traced back to the protocol where they originated. Additionally, Key Performance Indicators

(KPI) can be extracted from/identified within the process execution and can be further analyzed and used to anticipate subsequent outcomes and/or to guide the choice of one potential process design over others. Regulations and policies can also be enforced through the use of an HTN planner that strictly follows modeled protocols.

The various systems and methods described herein can be configured, such as based on various flexibility constraints and timescales, to knowledge worker declares temporal and other constraints over the elements involved in the process. The HTN temporal planner can search for a process that conforms to these constraints in any number of ways, such as the most appropriate and/or flexible way. In certain implementations the activities in the final process can be associated with various times and can be executed at any time within its associated temporal window.

In certain implementations, various protocols and/or doctrines can be represented based on goals to achieve. As described herein, such goals can parameterized with actors, resources and/or other elements involved in the goal resolution. Goals can also define constraints in relation to the different elements involved, or over the resources needed, or over the timing, which are imposed by the environment or by other regulations. In this way, such goals can declaratively describe/define the circumstances under which they can be achieved.

It can be appreciated that various goals can be solved in any number of alternative ways. Accordingly, various methods can be identified to model different alternative approaches to accomplish a goal. A method, as referenced herein, can also encompass a network of sub-goals and/or the precedence relation between these sub-goals. Methods can also define the circumstances (constraints) of applicability and various aspects of the temporal orchestration among the sub-goals. Heuristics, business rules, preferences and/or other expert knowledge can also be incorporated to better adapt the process to the organizational needs.

Moreover, certain goals, such as those simple enough to be directly executed, can be characterized as tasks. Such tasks can be thought of as individual executable elements that can form a process. Tasks, as goals or methods, can also be associated with a set of conditions that restrict the feasibility of a task. Additionally, tasks can also define the effects/outcome of their respective execution(s).

It should be understood that the referenced goals, methods and tasks can be implemented such that they (collectively and/or individually) define a template or pattern that guides the building of an executable process. Various strategies or environments can affect the manner in which various processes develop. Accordingly, the data (e.g., the constraints, personnel, etc.) can be the primary source that instantiates the template or templates that can foster a new adapted process. In doing so, such a process can be adapted to the contextual situation where the dynamicity of the data defines the most appropriate process to accomplish the target goals.

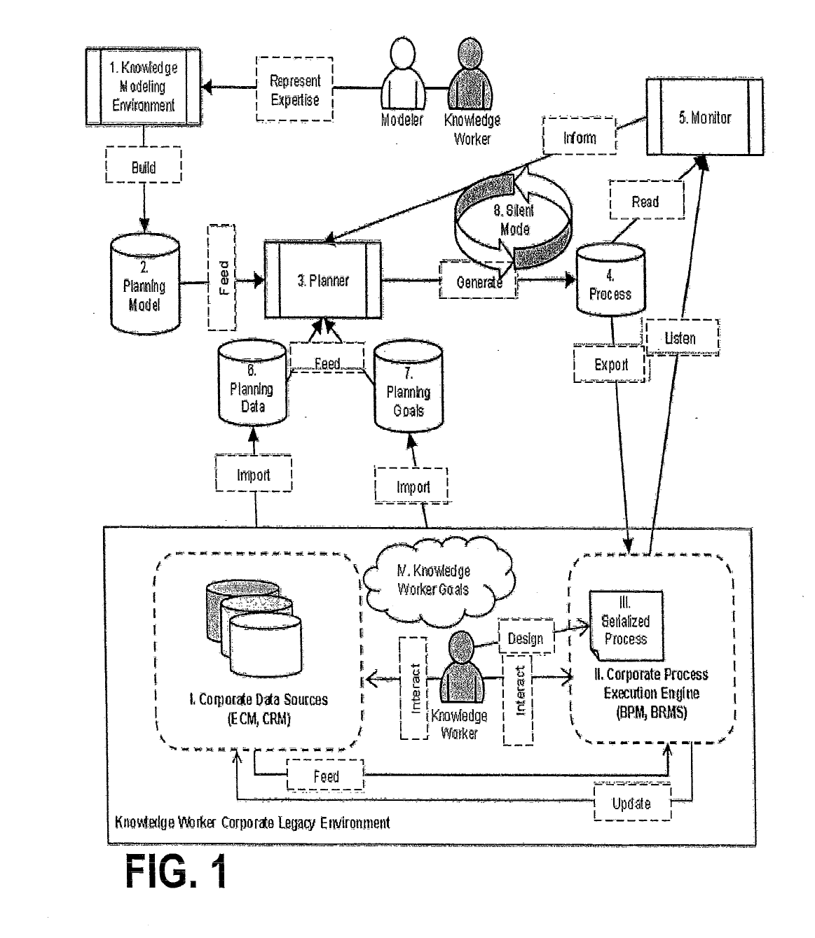

The systems and methods described herein incorporate various elements and components, such as those depicted in FIG. 1, and can include but are not limited to: A Knowledge Modeling Environment (KME) (1), which can be implemented, for example, as a software tool or application to edit and debug the knowledge representation of the problem/goal. This knowledge representation is also known as the Planning Model (2) and can include a Context Model (ontology of objects and entities that pertain to the problem/goal together with their respective relationship(s)) and Expert Knowledge (such as a representation of the skills, rules and constraints that can determine or direct the behavior of the knowledge worker). KME is also configured to analyze, compare and/or test/validate various solution processes, as well as to generate deployable software packages (such as those that can enable planning and/or monitoring, as described herein), thereby enabling further integration within larger systems.

Automated Planner (3) can be an automated HTN temporal planner. Planning Data (6) can be, for example, excerpts of Corporate Data Sources (I), such the information needed to solve a problem/achieve a goal. This planning data can be processed in order to conform to the ontology of the problem defined in the Context Model in the Planning Model (2). Accordingly, Planning Data (6) can be thought of as a ‘snapshot’ of the current scenario from which the goals must be achieved.

Planning Goals (7) can be statement(s)/formulation(s) of the problem/goal in terms of one or more goals that need to be achieved, based on the context defined in Planning Data (6). Process (4) corresponds to a sequence of tasks which enable achievement of the Planning Goals (7), such as based on the inner current scenario or context defined in Planning Data (6) according to the rules, expertise and constraints represented in the Planning Model (2).

Monitor (5) can be a tool/application that ‘listens’ to changes in the environment and is configured to detect deviations in the execution of a process with respect to its expected evolution. The changes can be detected, for example, from the data sources and/or can be signaled for the knowledge worker or other actors. Upon detecting a contingency during the execution of the process, the Monitor (5) can inform/notify the Planner (3) which may initiate a repeat of one or more planning process(es) and enabling resumption of the activity with a new Process (4) that is adapted to the new scenario or new changes detected by the Monitor (5).

Silent Mode operation (8) corresponds to operation of any number of the components described herein in closed loop following a cycle such as: Observe (e.g., extract Planning Data (6) and Planning Goals (7)), Orient and Decide (design a Process (4).), Act (execute the Process), and Observe (detect deviations with Monitor (5)). Such a process can repeat until all goals are achieved, including reacting to any contingency, process failure, change in the settings, change in the goals, changes (personalization) in the process, etc., while maintaining goal-oriented operation.

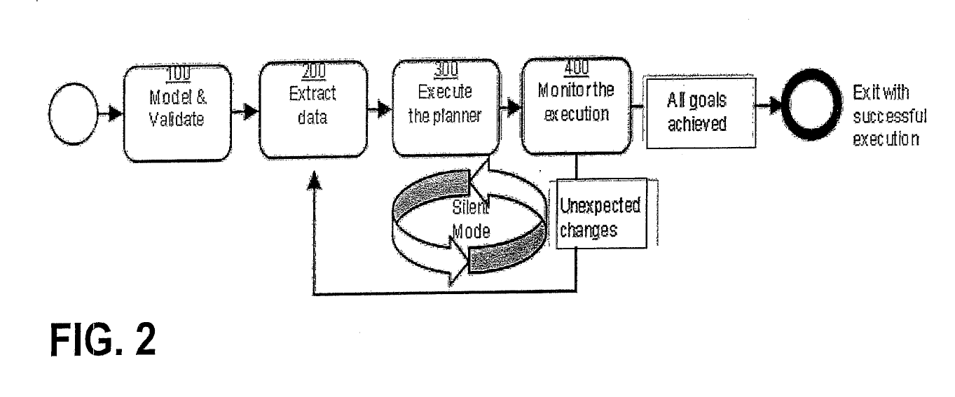

FIG. 2 is a flow diagram is described showing a routine that illustrates a broad aspect of a method for dynamic planning in accordance with at least one embodiment disclosed herein. As shown, various aspects of the expert knowledge can be analyzed (100) in order to model/represent it in a way understandable by the planner. Subsequently, a loop (‘Silent Mode’) can be cycled through (steps 200, 300 and 400), which provides continuous and ongoing support until all goals have been satisfied while reacting to different types of changes in the problem/goal, etc. Accordingly, upon detecting one or more changes (whether in the process or its associated data), one or more new processes can be generated/suggested in order to improve achievement of the goal(s).

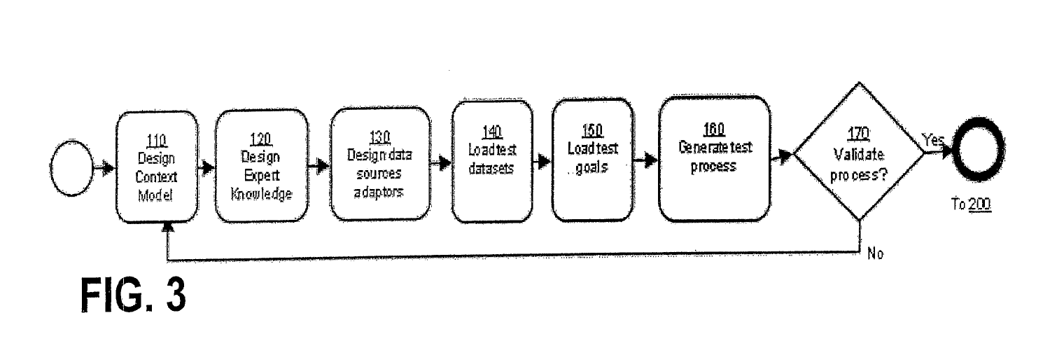

FIG. 3 depicts further aspects of step 100. It should be understood that, in certain implementations, step 100 enables to the delivery of a valid planning model that can be subsequently be exploited in the production loop of Silent Mode, and thus can be carried out at any point in time. At Step 110 the planning data model, named Context Model, can be designed, in order to accommodate the imported data (such as that coming from the KWLE). The Context Model can define the resources and/or other organizational elements available/required/preferred for the achievement of one or more goals. Resources, preferences, corporate information and/or other elements of the case can be represented in UML. Additionally, in certain implementations, an organizational structure can be defined/charted, such as using a hierarchical diagram. This structure defines actors and their competences/capabilities, the level of authorization for executing certain tasks, and/or the relations among them.

A representation of Expert Knowledge can be designed/generated at Step 120. Such an expert model can define or represent, such as in a goal driven formalism, the protocols followed by the organization. This information can be modeled in any number of ways, such as using a combination of EKMN and EKDL. It should be understood that any number of constraints and/or procedures can be imposed/required, such as based on standards and quality enforcing policies/rules. Moreover, in certain implementations, the referenced expert knowledge can correspond to business rules and/or corporate doctrine, such as that generated by an organization. Capacity use rules and/or other such constraints, such as in relation to various resources can also be modeled, in addition to externally imposed regulations and/or laws that pertain to a particular goal.

At step 130, a connector, such as one configured to interact with the different data services in the KWLE, can be designed. Such a connector can enable population of a particular model with real instances (e.g., current or historic scenarios). Such connectors can be defined to correspond with the different data services and data transformation and merging mechanisms can accordingly be incorporated to adapt the data to the needs of a particular Context Model.

Upon generating an initial planning model (Context Model and Expert Knowledge), such a model can be tested to determine various aspects of the effectiveness of the model. In certain implementations, various scenarios can be prepared/configured and used to test/audit if the processes offered by the planner are effective/efficient. In certain implementations, the use case scenarios can first check fine grain goals, and then increment the level of complexity. For example, at step 140, different test sets that instantiate the classes defined in CM can be filled. Connections mechanisms, data transformations and/or other tools/applications can be used to provide/fill this data. At step 150, the goal or goals to accomplish can be loaded and parameterized accordingly. At step 160 the process can be tested in relation to different parameters and configurations. At step 170, tools for comparing the processes based on different KPIs can be used within the KME. Different tools for the visualization of processes can also be implemented during the validation. Also, assertion check scripts can be executed against the resulting process. If the validation is successful and the model is complete with respect to the organization requirements then the process can further continue to steps 200-400. Otherwise, the process can return to step 110 and the process can be repeated.

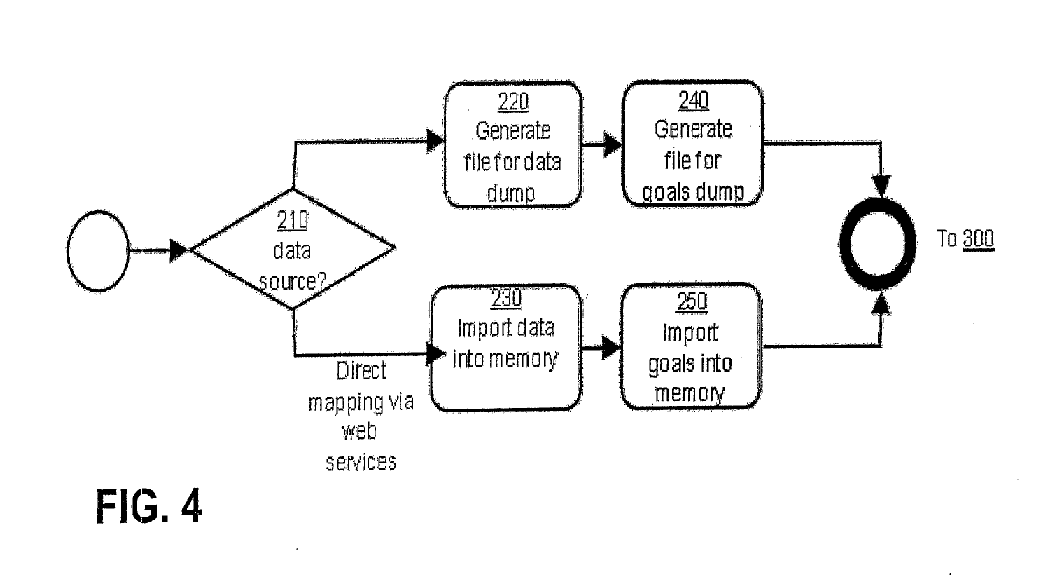

FIG. 4 depicts step 200 in further detail. The process is operative to provide the planner with updated data about the context and/or the goals, and can be executed every time a process is required (whether from scratch, such as for a new goal, and/or from a failure of a previous plan, such as in light of an unexpected change in the environment). The data provided to process can be processed in any number of different ways. Steps 220 and 240 facilitate communication with the planner, such as through intermediate files. The data to populate such intermediate files can be obtained, for example, from KWLE through various data adaptors. Steps 230 and 250 enable the obtaining of such data directly into memory, such as through the use of web services.

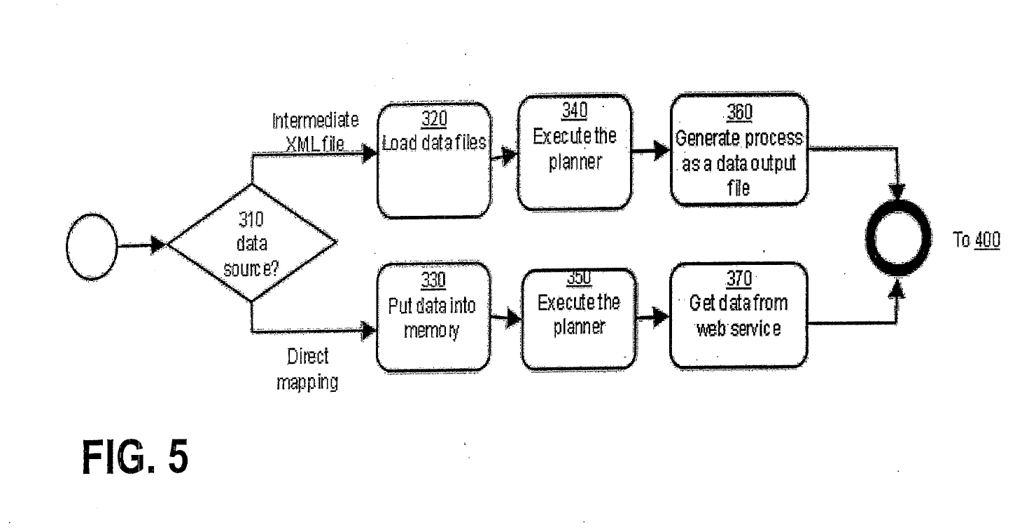

FIG. 5 depicts the execution of the planner in step 300, such as in scenarios that can depend on the data gateways used in step 200. At step 320, the planner can obtain/be provided with data files, at step 340 the planner can be executed, and at step 360 a process can be generated such as an intermediate file. Moreover, at step 330 the planner can be provided with data originating from web services, at step 350 the planner can be executed, and at step 370 the process can be generated and exported, such as through web services.

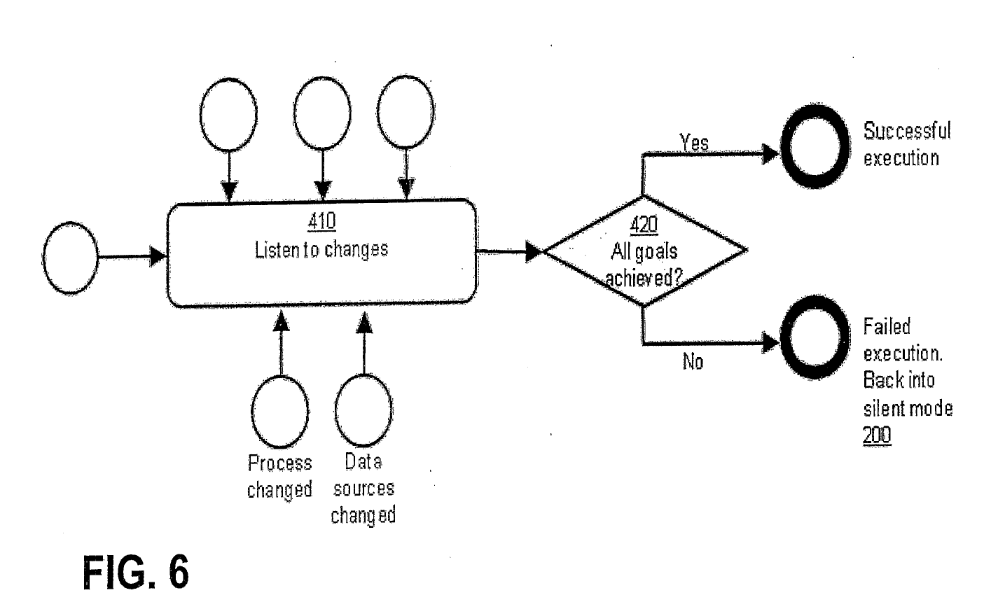

FIG. 6 depicts an exemplary operation of the Monitor. In certain implementations, the Monitor can be connected to the process execution engine in KWLE to listen (410) to the evolution of the execution of a process. In doing so, deviations, such as those pertaining to the expected evolution of the execution of a process towards the goals, can be detected, the planner can accordingly be triggered to resume activity in order to continue alignment towards the defined goals. Examples of such changes include: changes in the execution of the task of a process (tasks whose execution might have failed or which have been canceled, or tasks under execution whose termination is being delayed due to exogenous reasons which put various aspects of the remaining process at risk), changes in the original goals, changes in the data sources which could deviate the execution of the remaining aspects of the plan, and/or changes in the structure or composition of the process (such as those introduced voluntarily/discretionarily).

Upon determining that all the tasks in a process have been finished (420), then all the goals have been achieved and the whole artifact ends with success. Otherwise, should any of the previous conditions be detected, then the Monitor can trigger the planner back (silent mode) to gather data for that new context, and design a new process, such as based on the previous one(s), to resume activity towards the remaining goals in a non-stop loop until all goals had been achieved. Additionally, at various intervals (such as upon completion of a particular plan) various machine learning and/or other such analysis techniques can be applied to learn/identify parameters and/or patterns from the history in order to further improve/refine the model, such as for future reuse.

By way of illustration, the systems and methods described herein can be implemented in healthcare related settings such as in support of a specialist in pediatric oncology who is faced with treating a new patient, such as a patient diagnosed with Hodgkin's lymphoma. It can be appreciated that a patient treatment plan that provides information relating to the timing, the resources needed, the problems or risks that may arise during the process, etc., can be developed. Accordingly, based on the initial information provided, early/preemptive decisions that can significantly impact/improve patient recovery can be implemented. It can be further appreciated that any plan that is generated can be further re-generated/refined upon determining that an event such as an unexpected event (e.g., one that puts the patient at risk) has occurred. Accordingly, the techniques and operations described herein can facilitate improved decision making, thereby also increasing the quality and safety of the treatments.

As described herein, models can be developed, such as based on a set of protocols (e.g., oncology protocols pertaining to Hodgkin's lymphoma, such as EURONET PHL C1) that can be used as base for the modeling in EKMN EKDL.

It can be appreciated that Hodgkin's lymphoma is often treated with chemotherapy and radiotherapy or combinations of both. Though each form of therapy is often successful, each one also entails its own timing, associated resources, contraindications and short/long-term side effects. It can be further appreciated that certain protocols and treatments can depend on local regulations/requirements. Additionally, an organization can have its own preferences and constraints, such as those learned/developed from previous experiences. All of these items can be integrated within the model.

Using such a model, various aspects of the status of a particular patient can be processed in order to establish the goals that the final treatment should accomplish. Such goals can be parameterized and ordered in time as needed. High level goals can be combined with more fine grained goals depending, for example, on the control a user (such as a doctor) intends to exert over the final process. Accordingly, different scenarios with different goals and parameters can be analyzed and compared. In doing so, a user (such as a doctor) can utilize the model and a planning algorithm to explore different detailed processes in different scenarios. Moreover, various suggestions can be provided in order to account for any number of alternatives. Considerations that can be accounted for include, but are not limited to: That various types of cancer require long term treatments. Accordingly, a large number of variables are necessary to account for a complete treatment regimen. With the planner, any number of alternatives can be explored as needed. Moreover, any such treatments can be adapted to the needs of a particular patient. Correct dosage and schedules for each drug can also be calculated with accuracy. The planner is also configured to analyze organizational resources availability, politics and/or any other such constraints and/or combine them to identify one or more processes that meet them. Additionally, the model can homogenize the treatments within the organization. Moreover, the referenced models can be generated based on quality guides, standards, regulations and/or previous trials and experiences, such as those that increment the treatments reliability.

Upon identifying one or more processes (e.g., treatments) that meets the marked goals, execution can begin. However, in many circumstances the dynamics of the environment in relation to which the process should be adapted and modified can be considered. For example, patient tests can reveal unexpected contingencies or certain resources may not be available when needed. Accordingly, a registry of the treatment modifications can be maintained and consulted/considered as such factors change. A process monitoring tool can identify such problems in advance and further enable various countermeasures by adapting the plan as necessary. Additionally, a history of the case can be maintained.

Upon detecting various changes, such as those that prevent the correct/optimal execution/implementation of the process, the plan can be regenerated to better define a treatment plan that best fits the patient needs and the new scenario. Additionally, at any time the process can be regenerated based on the current context of execution.

Moreover, the systems and methods described herein can be configured to enable the synthesis and leveraging of previous experience(s) when regenerating a process. Machine learning techniques can be implemented to account for comparable historic cases, enabling the identification of common patterns and inference of the best parameters to further improve and refine the encoded modeled protocols, thereby continuously improving the quality of the treatment offered to the patient.

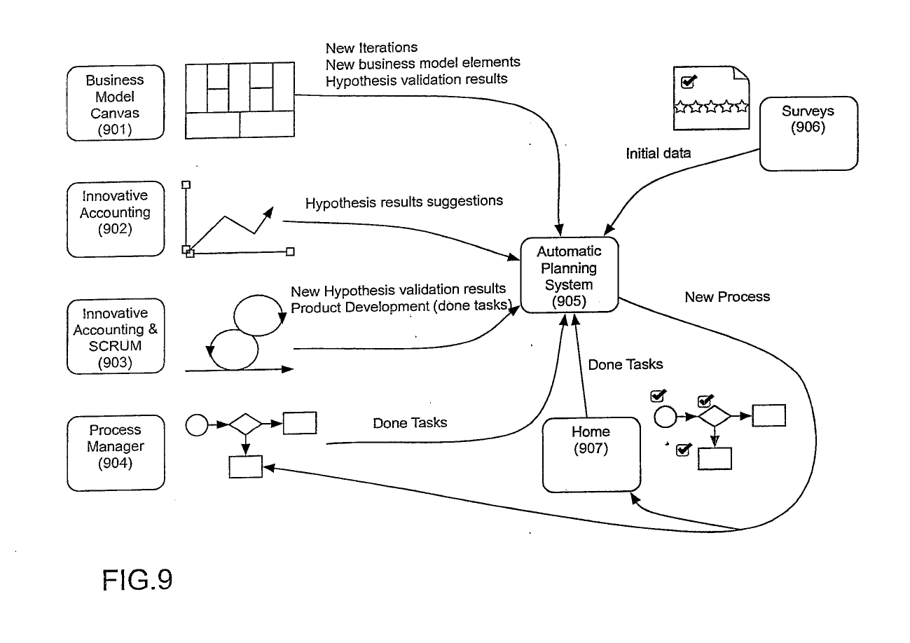

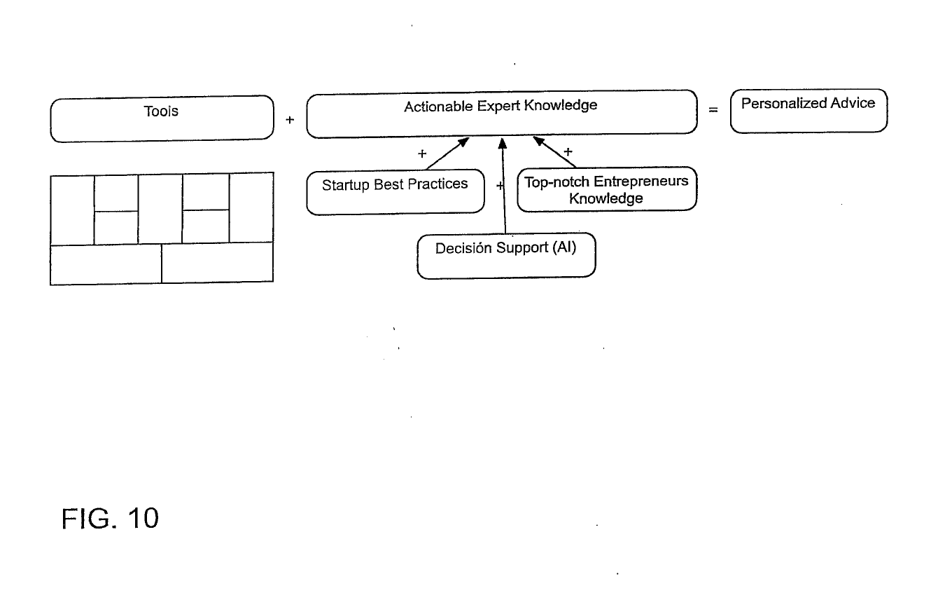

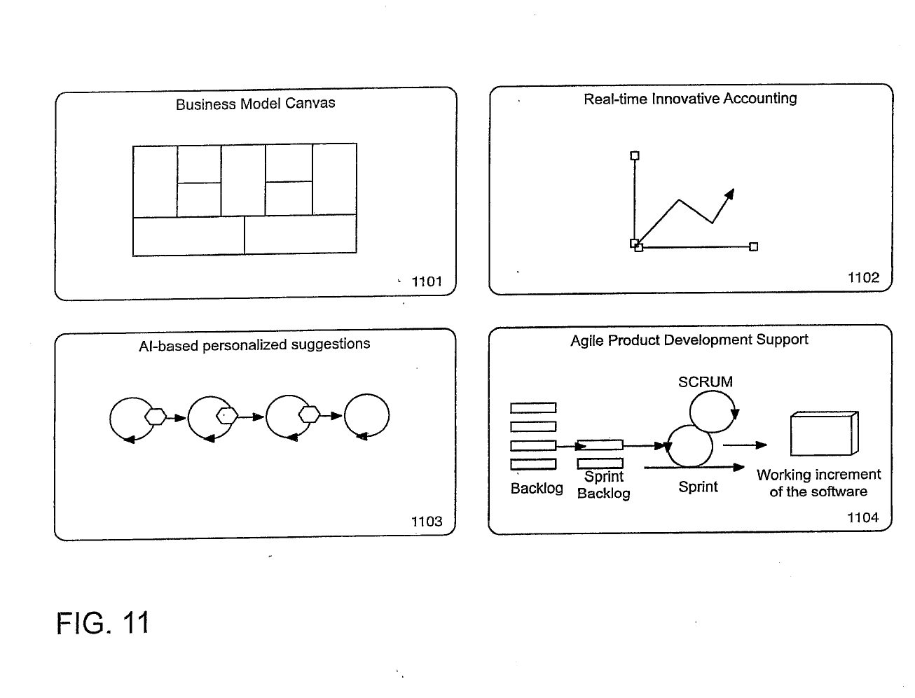

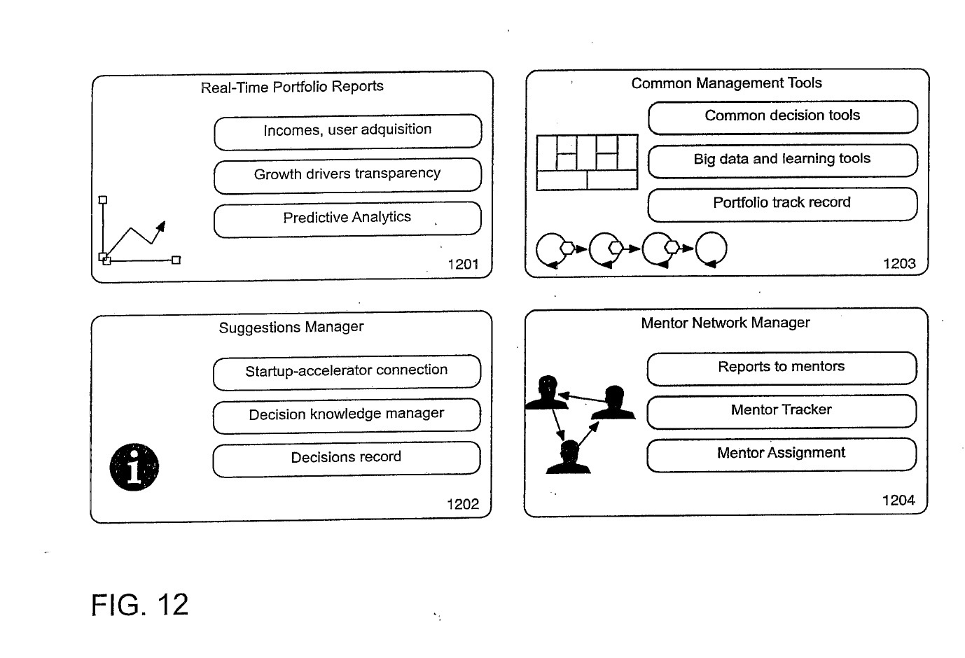

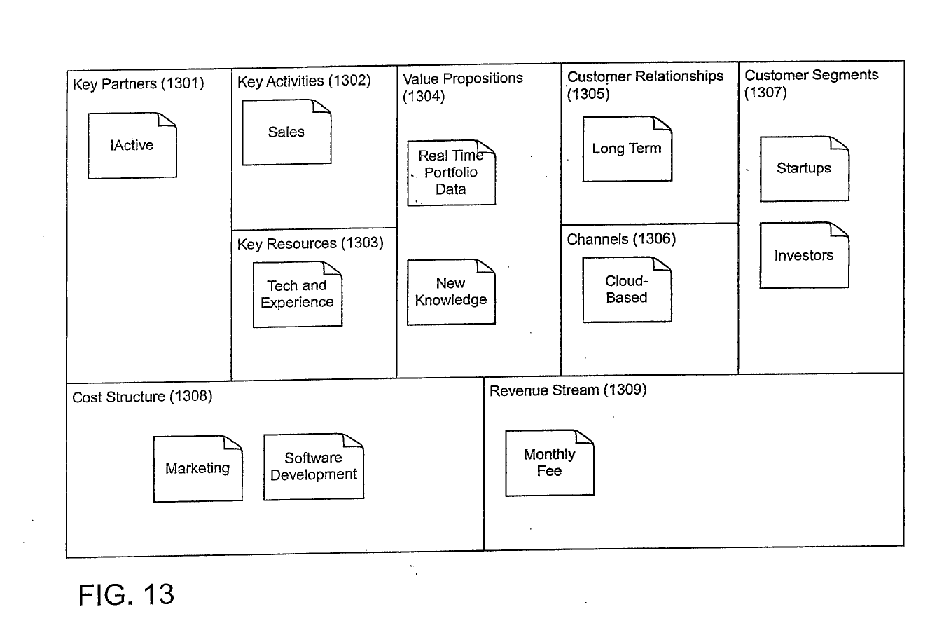

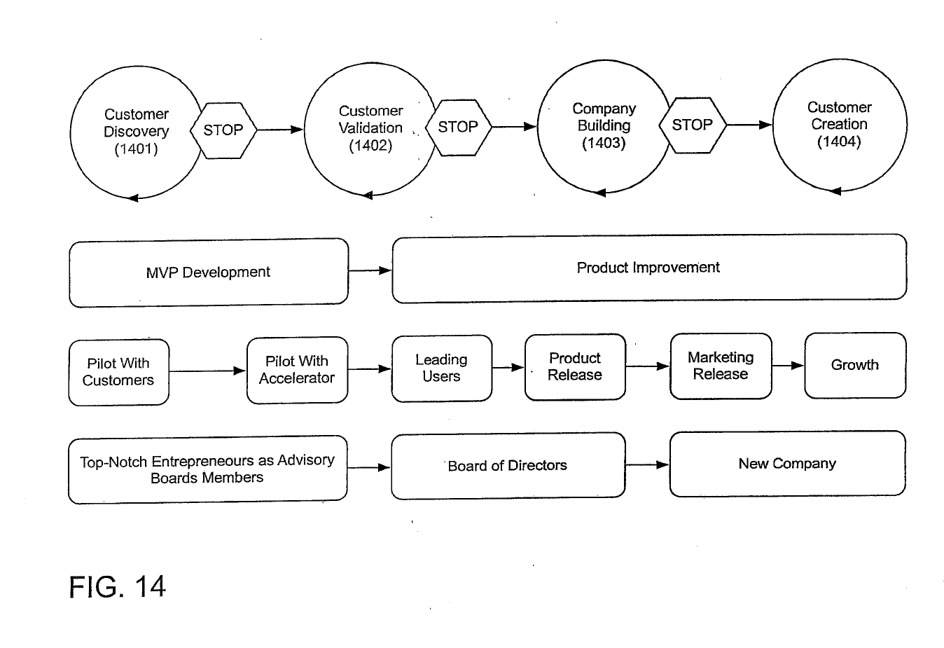

By way of further illustration, FIGS. 9-14 depict various aspects, features, operations, and illustrations of any number of the various systems and methods described herein. It will be appreciated by those of ordinary skill in the art that the various systems and methods, such as those described above with respect to treating various medical conditions, can be similarly employed in other contexts, such as those relating to creating start-up companies, including contexts in which ‘lean methodologies’ are employed. It should be further noted that these (and other) implementations are within the scope of the systems and methods described herein.

The operation of the dynamic planning system 700 and the various elements and components described above will be further appreciated with reference to the method for dynamic planning as described herein.

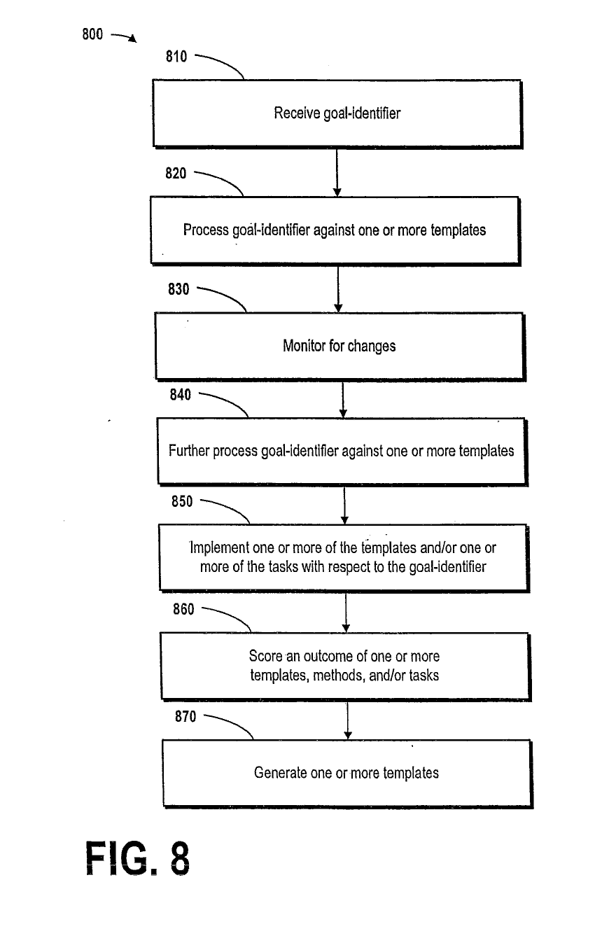

Turning now to FIG. 8, a flow diagram is described showing a routine 800 that illustrates a broad aspect of a method for dynamic planning in accordance with at least one embodiment disclosed herein. It should be appreciated that several of the logical operations described herein are implemented (1) as a sequence of computer implemented acts or program modules running on dynamic planning system 700 and/or (2) as interconnected machine logic circuits or circuit modules within the dynamic planning system 700. The implementation is a matter of choice dependent on the requirements of the device (e.g., size, energy, consumption, performance, etc.). Accordingly, the logical operations described herein are referred to variously as operations, steps, structural devices, acts, or modules. As referenced above, various of these operations, steps, structural devices, acts and modules can be implemented in software, in firmware, in special purpose digital logic, and any combination thereof. It should also be appreciated that more or fewer operations can be performed than shown in the figures and described herein. These operations can also be performed in a different order than those described herein.

At 810, processor 710 executing one or more of software modules 730, including, in certain implementations, dynamic planning application 770, configures computing device 705 to receive a goal-identifier. In certain implementations, the goal-identifier can correspond to an achievement of one or more objectives. For example, such a goal-identifier can be provided by a user (such as a knowledge worker), reflecting a particular goal that is desired to be achieved (e.g., treatment of a patient having a particular disease, completing a particular project such as building a house, etc.). Moreover, in certain implementations the goal-identifier can include one or more actor parameters (e.g., the number of personnel available for a project, varying degrees of skill of each of the personnel, etc.), one or more resource parameters (e.g., the materials, equipment, budget, etc., that are available for a given project), and/or one or more constraints (e.g., one or more regulations or limitations that may be imposed on the performance of a particular project, such as no construction work from the hours of 6:00 pm-7:00 am).

At 820, processor 710 executing one or more of software modules 730, including, in certain implementations, dynamic planning application 770, configures computing device 705 to process a goal-identifier (such as the goal-identifier received at 810) against one or more templates. In certain implementations, such templates can include one or more methods. For example, various databases can be maintained, containing templates having methods for various projects/activities (e.g., ways to treat various types of diseases, ways to build certain types of buildings, etc.). Each of such methods can, in turn, include one or more actor parameters, one or more resource parameters, one or more constraints, and/or one or more tasks. For example, each method (e.g., stage 1 of a cancer treatment, stage 2 of a cancer treatment, etc.) can be associated with various actor parameters (e.g., the number of personnel required/preferred in order to properly execute a particular method, the degrees of skill required of each of such personnel, etc.), one or more resource parameters (e.g., the materials, equipment, budget, etc., that are required/preferred in order to properly execute a particular method), one or more constraints (e.g., one or more regulations or limitations that will be imposed on the execution of a particular method), and/or one or more tasks (e.g., various activities or actions that make up a particular method). Moreover, in certain implementations, each of such tasks can, in turn, include one or more actor parameters, one or more resource parameters, and/or one or more constraints. In processing the goal-identifier against various templates, one or more of the templates having comparable and/or complimentary respective actor parameters, resource parameters, and/or constraints to the goal-identifier and/or one or more of the tasks having comparable and/or complimentary respective actor parameters, resource parameters, and/or constraints to the goal-identifier can be identified. That is, it can be appreciated that there may be any number of parallel methods that can enable the achievement of a particular goal. However, each such method can entail a unique set of actor parameters, resource parameters, constraints, and/or one or more tasks. Accordingly, by processing a particular goal-identifier (having its own actor parameters, resource parameters, and/or constraints), those methods that are most comparable/compatible with the circumstances surrounding the goal-identifier can be identified. For example, while certain methods of disease treatment may require larger or more specialized personnel or resources, in a setting where such personnel/resources are unavailable, one or more other methods that are comparable/compatible with the specific situation can be identified.

At 830, processor 710 executing one or more of software modules 730, including, in certain implementations, dynamic planning application 770, configures computing device 705 to monitor for one or more changes. In certain implementations, such changes can pertain to one or more actor parameters, one or more resource parameters, and/or one or more constraints of the goal-identifier (such as those identified at 820). For example, it can be appreciated that, over the course of a particular process, such as the treatment of a patient or the building of a house, various changes, such as unexpected complications, can occur. Moreover, in certain implementations, one or more changes can be monitored for with respect to a scoring (such as the scoring at 860, as described herein).

At 840, processor 710 executing one or more of software modules 730, including, in certain implementations, dynamic planning application 770, configures computing device 705 to further process a goal-identifier (such as the goal-identifier received at 810) against one or more templates. In certain implementations, such processing can be performed based on a determination of the one or more changes (such as those monitored for at 830). In processing the goal-identifier against the various templates, one or more of the templates having comparable and/or complimentary respective actor parameters, resource parameters, and/or constraints and/or one or more of the one or more tasks having comparable and/or complimentary respective actor parameters, resource parameters, and/or constraints can be identified. Moreover, in certain implementations, such comparable/complimentary templates and/or tasks can be identified with respect to one or more changes (such as those monitored for at 830). That is, having identified the referenced changes, a further processing of the goal-identifier, as changes, can be performed with respect to the various templates, substantially in the manner described at 820. In doing so, the identified changes can be accounted for, thereby enabling methods to be identified in light of changing circumstances that were not initially identified prior to the occurrence of the identified change.

At 850, processor 710 executing one or more of software modules 730, including, in certain implementations, dynamic planning application 770, configures computing device 705 to implement one or more of the templates and/or one or more of the tasks (such as those identified at 840) with respect to the goal-identifier. That is, having identified a particular template as being optimal for achievement of a goal in light of an identified change, such an identified template can be implemented within the process in lieu of a previously implemented template. Alternatively, in certain implementations only a section or portion of the identified template can be implemented (such as the portion that is directed towards the aspect(s) in relation to which the change occurred), upon completion of which the initially implemented template can be resumed. It should be further appreciated that shifting between two templates can be difficult in certain circumstances (e.g., if the templates each require substantially different personnel, resources, etc.), and the difficulty in shifting between two templates can also be considered in determining an optimal approach. Moreover, in certain implementations, one or more suggestions can be provided with respect to the templates and/or the tasks. For example, a user can be provided with a prompt or suggestion alerting him/her to various alternative templates that can be implemented in light of the change, and the user can select whether or not to avail himself/herself of such alternatives.

At 860, processor 710 executing one or more of software modules 730, including, in certain implementations, dynamic planning application 770, configures computing device 705 to score an outcome of one or more of the templates, one or more of the methods, and/or one or more of the tasks (such as those implemented at 850). In certain implementations, an outcome of the templates, the methods, and/or the tasks can be scored in relation to the achievement of the one or more objectives. That is, it can be appreciated that while any number of templates can achieve a particular goal, some templates may achieve the goal relatively better/worse than others. For example, one template may achieve a goal more expediently and/or more cost efficiently than another, despite the fact that both approaches met all the defined requirements. As such, the performance of various templates, methods, and/or tasks can be scored, such that the effectiveness of each one can be quantified, at least with respect to one another.

At 870, processor 710 executing one or more of software modules 730, including, in certain implementations, dynamic planning application 770, configures computing device 705 to generate one or more templates. In certain implementations, one or more methods from a first template can be combined with one or more methods from a second template. That is, it can be appreciated that in addition to storing previously generated/created templates, additional templates can be generated. For example, having identified one method contained within one template as being particularly effective, and another method from another template as also being effective, the two methods (if appropriately compatible) can be combined into a new template. In doing so, further templates can be created based on the observed performance of prior templates (reflecting both the strengths and/or weaknesses of existing templates). Moreover, in certain implementations, one or more of the templates can be generated based on a scoring (such as the scoring at 860).

At this juncture, it should be noted that although much of the foregoing description has been directed to systems and methods for dynamic planning, the systems and methods disclosed herein can be similarly deployed and/or implemented in scenarios, situations, and settings far beyond the illustrated scenarios. It can be readily appreciated that dynamic planning system 700 can be effectively employed in practically any scenario where any/all of the operation described herein can be useful, including but not limited to: crisis and emergency management, tourism and travel, electronic games, education, banking, marketing and finances, and/or sports. It should be further understood that any such implementation(s) and/or deployment(s) are within the scope of the systems and methods described herein.

It is to be understood that like numerals in the drawings represent like elements through the several figures, and that not all components and/or steps described and illustrated with reference to the figures are required for all embodiments or arrangements. It should also be understood that the embodiments, implementations, and/or arrangements of the systems and methods disclosed herein can be incorporated as a software algorithm, application, program, module, or code residing in hardware, firmware and/or on a computer useable medium (including software modules and browser plug-ins) that can be executed in a processor of a computer system or a computing device to configure the processor and/or other elements to perform the functions and/or operations described herein. It should be appreciated that according to at least one embodiment, one or more computer programs, modules, and/or applications that when executed perform methods described herein need not reside on a single computer or processor, but can be distributed in a modular fashion amongst a number of different computers or processors to implement various aspects of the systems and methods disclosed herein.

Thus, illustrative embodiments and arrangements of the present systems and methods provide a computer implemented method, computer system, and computer program product for dynamic planning. The flowchart and block diagrams in the figures illustrate the architecture, functionality, and operation of possible implementations of systems, methods and computer program products according to various embodiments and arrangements. In this regard, each block in the flowchart or block diagrams can represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the present invention, which is set forth in the following claims.

What is claimed is:

1. A computer-implemented method comprising:
receiving a goal-identifier, the goal-identifier corresponding to an achievement of one or more objectives and comprising:
(a) one or more actor parameters,
(b) one or more resource parameters, and
(c) one or more constraints;
processing, with one or more processors, the goal-identifier against a plurality of templates, each of the templates comprising one or more methods, each of the one or more methods comprising:
(a) one or more actor parameters,
(b) one or more resource parameters,
(c) one or more constraints, and
(d) one or more tasks, and
each of the one or more tasks comprising:
(a) one or more actor parameters,
(b) one or more resource parameters, and
(c) one or more constraints,
in order to identify at least one of (a) one or more of the plurality of templates and (b) one or more of the one or more tasks having comparable respective actor parameters, resource parameters, and constraints;
monitoring for one or more changes with respect to at least one of:
(a) the one or more actor parameters,
(b) the one or more resource parameters, and
(c) the one or more constraints
of the goal-identifier;
based on a determination of the one or more changes, further processing the goal-identifier against the plurality of templates in order to identify, with respect to the one or more changes, at least one of (a) one or more of the plurality of templates and (b) one or more of the one or more tasks having comparable respective actor parameters, resource parameters, and constraints; and
implementing the at least one of (a) one or more of the plurality of templates and (b) one or more of the one or more tasks with respect to the goal-identifier.

2. The method of claim 1, further comprising generating one or more of the templates.

3. The method of claim 2, wherein generating one or more of the templates comprises combining one or more methods from a first template with one or more methods from a second template.

4. The method of claim 1, further comprising scoring an outcome of at least one of (a) the templates, (b) the one or more methods, and (c) the one or more tasks.

5. The method of claim 4, wherein scoring an outcome comprises scoring an outcome of at least one of (a) the templates, (b) the one or more methods, and (c) the one or more tasks in relation to the achievement of the one or more objectives.

6. The method of claim 4, further comprising generating one or more of the templates based on the scoring.

7. The method of claim 4, wherein monitoring for one or more changes comprises monitoring for one or more changes with respect to the scoring.

8. The method of claim 1, wherein implementing the at least one of (a) one or more of the plurality of templates and (b) one or more of the one or more tasks comprises providing one or more suggestions with respect to the at least one of (a) the one or more of the plurality of templates and (b) the one or more of the one or more tasks.

9. The method of claim 1, wherein the at least one of (a) one or more of the plurality of templates and (b) one or more of the one or more tasks having comparable respective actor parameters, resource parameters, and constraints comprises at least one of (a) one or more of the plurality of templates and (b) one or more of the one or more tasks having complimentary respective actor parameters, resource parameters, and constraints.

10. A system comprising: one or more processors configured to interact with a computer-readable medium in order to perform operations comprising:
receiving a goal-identifier, the goal-identifier corresponding to an achievement of one or more objectives and comprising:
(a) one or more actor parameters,
(b) one or more resource parameters, and
(c) one or more constraints;
processing the goal-identifier against a plurality of templates, each of the templates comprising one or more methods, each of the one or more methods comprising:
(a) one or more actor parameters,
(b) one or more resource parameters,
(c) one or more constraints, and
(d) one or more tasks, and
each of the one or more tasks comprising:
(a) one or more actor parameters,
(b) one or more resource parameters, and
(c) one or more constraints,
in order to identify at least one of (a) one or more of the plurality of templates and (b) one or more of the one or more tasks having comparable respective actor parameters, resource parameters, and constraints;
monitoring for one or more changes with respect to at least one of:
(a) the one or more actor parameters,
(b) the one or more resource parameters, and
(c) the one or more constraints
of the goal-identifier;
based on a determination of the one or more changes, further processing the goal-identifier against the plurality of templates in order to identify, with respect to the one or more changes, at least one of (a) one or more of the plurality of templates and (b) one or more of the one or more tasks having comparable respective actor parameters, resource parameters, and constraints; and
implementing the at least one of (a) one or more of the plurality of templates and (b) one or more of the one or more tasks with respect to the goal-identifier.

11. The system of claim 10, further configured to perform operations comprising: generating one or more of the templates.

12. The system of claim 11, wherein generating one or more of the templates comprises combining one or more methods from a first template with one or more methods from a second template.

13. The system of claim 10, further configured to perform operations comprising: scoring an outcome of at least one of (a) the templates, (b) the one or more methods, and (c) the one or more tasks.

14. The system of claim 13, wherein scoring an outcome comprises scoring an outcome of at least one of (a) the templates, (b) the one or more methods, and (c) the one or more tasks in relation to the achievement of the one or more objectives.

15. The system of claim 13, further configured to perform operations comprising: generating one or more of the templates based on the scoring.

16. The system of claim 13, wherein monitoring for one or more changes comprises monitoring for one or more changes with respect to the scoring.

17. The system of claim 10, wherein implementing the at least one of (a) one or more of the plurality of templates and (b) one or more of the one or more tasks comprises providing one or more suggestions with respect to the at least one of (a) the one or more of the plurality of templates and (b) the one or more of the one or more tasks.

18. The system of claim 10, wherein the at least one of (a) one or more of the plurality of templates and (b) one or more of the one or more tasks having comparable respective actor parameters, resource parameters, and constraints comprises at least one of (a) one or more of the plurality of templates and (b) one or more of the one or more tasks having complimentary respective actor parameters, resource parameters, and constraints.

19. A computer storage medium encoded with a computer program, the program comprising instructions that when executed by one or more data processing apparatus cause the one or more data processing apparatus to perform operations comprising:
receiving a goal-identifier, the goal-identifier corresponding to an achievement of one or more objectives and comprising:
(a) one or more actor parameters,
(b) one or more resource parameters, and
(c) one or more constraints;
processing the goal-identifier against a plurality of templates, each of the templates comprising one or more methods, each of the one or more methods comprising:
(a) one or more actor parameters,
(b) one or more resource parameters,
(c) one or more constraints, and
(d) one or more tasks, and
each of the one or more tasks comprising:
(a) one or more actor parameters,
(b) one or more resource parameters, and
(c) one or more constraints,
in order to identify at least one of (a) one or more of the plurality of templates and (b) one or more of the one or more tasks having comparable respective actor parameters, resource parameters, and constraints;
monitoring for one or more changes with respect to at least one of:
(a) the one or more actor parameters,
(b) the one or more resource parameters, and
(c) the one or more constraints
of the goal-identifier;
based on a determination of the one or more changes, further processing the goal-identifier against the plurality of templates in order to identify, with respect to the one or more changes, at least one of (a) one or more of the plurality of templates and (b) one or more of the one or more tasks having comparable respective actor parameters, resource parameters, and constraints; and
implementing the at least one of (a) one or more of the plurality of templates and (b) one or more of the one or more tasks with respect to the goal-identifier.

20. The computer storage medium of claim 19, wherein implementing the at least one of (a) one or more of the plurality of templates and (b) one or more of the one or more tasks comprises providing one or more suggestions with respect to the at least one of (a) the one or more of the plurality of templates and (b) the one or more of the one or more tasks.
